(19) United States
(12) Patent Application Publication
(10) Pub. No.: US 2015/0049162 A1
(43) Pub. Date: Feb. 19, 2015

(54) Panoramic Meeting Room Video Conferencing With Automatic Directionless Heuristic Point Of Interest Activity Detection And Management

(71) Applicant: Futurewei Technologies, Inc., Plano, TX (US)

(72) Inventors: Francis Kurupacheril, Cupertino, CA (US); Dennis Episkopos, Westminster, CO (US)

(73) Assignee: Futurewei Technologies, Inc., Plano, TX (US)

(21) Appl. No.: 13/967,453

(22) Filed: Aug. 15, 2013

(51) Int. Cl. H04N 7/15; H04N 5/232

(52) U.S. Cl. CPC H04N 7/15; H04N 5/23238
USPC 348/14.08

(57) ABSTRACT

A conferencing apparatus comprising a memory, a processor coupled to the memory, wherein the memory contains instructions that when executed by the processor cause the apparatus to receive a video stream, evaluate the video stream for a plurality of participants, detect an interest activity of at least one of the plurality of participants, and increase a prominence of a portion of the video stream associated with the at least one of the plurality of participants based on the detected activity.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Multimedia, telepresence, and/or video conferences that involve multiple users at remote locations are becoming increasingly popular. In multimedia conference communications, multiple video objects from different sources may be transmitted to a common location where they may be received, processed and displayed together. Multimedia conference communication systems may thus allow multiple participants to communicate in a real-time meeting over a network. The multimedia conference communication interfaces have historically displayed different types of media content using various graphical user interface (GUI) windows or views. For example, one GUI view might include video images of participants, another GUI view might include presentation slides, yet another GUI view might include text messages between participants, and so forth.

However, difficulties may arise when trying to display all of the participants of a multimedia conference meeting. This problem may increase as the number of meeting participants increases, since some participants may not be displayed while speaking. Furthermore, a display cluttered with participants may make it difficult to identify a particular speaker at any given moment in time, particularly when multiple participants are speaking simultaneously or in rapid sequence or when the display area is comparatively limited in size.

### SUMMARY

In one embodiment, the disclosure includes a conferencing apparatus comprising a memory, a processor coupled to the memory, wherein the memory contains instructions that when executed by the processor cause the apparatus to receive a video stream, evaluate the video stream for a plurality of participants, detect an interest activity of at least one of the plurality of participants, and increase a prominence of a portion of the video stream associated with the at least one of the plurality of participants based on the detected activity.

In another embodiment, the disclosure includes a method of video conferencing comprising obtaining a first video stream, analyzing the media stream to identify a plurality of video conference participants, recording the identities of each participant in separate entries in a roster, decoding the first video stream to produce a second video stream, wherein the second video stream comprises at least one perspective video of at least one participant in the video conference, detecting an interest activity in the second video stream, correlating the interest activity to an entry in the roster, recording the correlation in the roster, and configuring the second video stream to display video of the at least one participant at a location geographically remote from the camera based on the interest activity.

In yet another embodiment, the disclosure includes a computer program product comprising computer executable instructions stored on a non-transitory medium that when executed by a processor cause the processor to identify a first participant and a second participant in a video conference media stream, record the identities of the first participant and the second participant in a roster, detect an interest activity from the first participant, using the occurrence of the interest activity to generate a prominence score, recording the prominence score in the roster; and prepare a display stream comprising the first participant and the second participant depicted in a perspective view according to their prominence score.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a rendering of an embodiment of a multimedia conference.

FIG. 2 is a schematic diagram of an embodiment of a network element.

FIG. 3 is a flowchart describing a process of capturing and/or processing multimedia conference information using a multimedia conference device.

FIG. 4 is a first embodiment of a GUI for a visual display at an end user location for a multimedia conference utilizing an embodiment of a process of capturing and/or processing multimedia conference information.

FIG. 5 is a second embodiment of a GUI for a visual display at an end user location for a multimedia conference utilizing an embodiment of a process of capturing and/or processing multimedia conference information.

FIG. 6 is a third embodiment of a GUI for a visual display at an end user location for a multimedia conference utilizing an embodiment of a process of capturing and/or processing multimedia conference information.

FIG. 7 is a fourth embodiment of a GUI for a visual display at an end user location for a multimedia conference utilizing an embodiment of a process of capturing and/or processing multimedia conference information.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments, some of which may utilize a non-directional or 360° lens to capture a meeting room multimedia conference and perform certain operations to make the conference display and/or interface more intelligible to one or more geographically remote viewers, e.g., by digitally reconstructing a three dimensional version of the room and disaggregating the reconstructed version into perspective views of each participant. Such various embodiments include embodiments in which a display is dynamically and/or preferentially configured, e.g., by aligning the participants in perspective and/or side-by-side displays, by eliminating negative space between participants, by (manually or automatically) identifying key or primary participants and placing them more prominently, by visually suppressing less active participants, by focusing on the speaker/doer, etc. Some embodiments may include consoles arranged to participate in a multimedia event by connecting to a centralized server. Certain embodiments may display various types of media at each or any console during the multimedia conference, e.g., video, text, a chat feed, documents, presentation slides, musical scores, etc. Some embodiments may keep certain media limited to specified participants, while other embodiments make certain media available to all participants or others not participating in the multimedia conference.

A multimedia conference system may include a multimedia conference server or other processing device arranged to provide web conferencing services. For example, a multimedia conference system may include a meeting device for displaying, collecting, storing, and/or sending various media from the meeting, a meeting server controlling and mixing various media to create and/or present the multimedia conference to an end user, and an end user device for displaying, collecting, storing, and/or sending various media from the end user(s). A multimedia conference may refer to any multimedia conference, collaboration, meeting, and/or telepresence event offering various types of multimedia information in a real-time or generally live online environment.

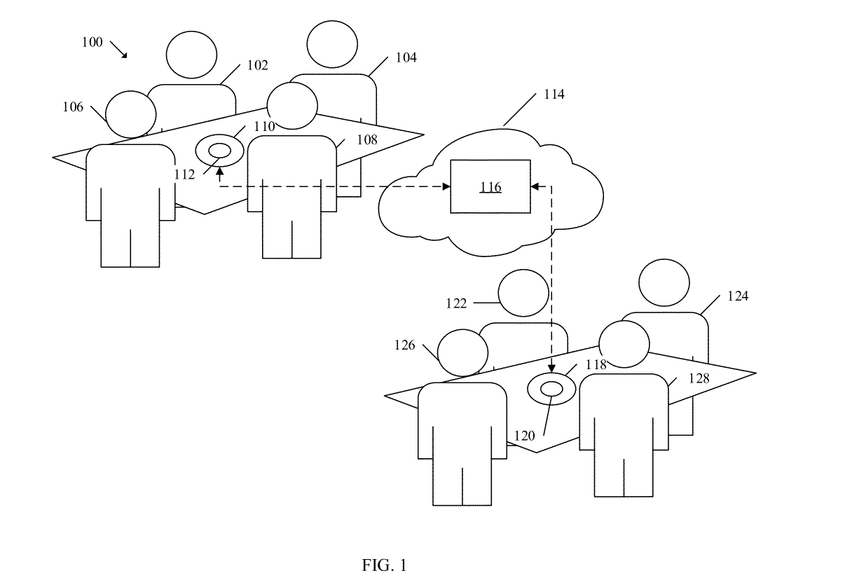

FIG. 1 is a rendering of an embodiment of a multimedia conference 100. At a first location, end users or participants 102-108 are shown around a multimedia conference device 110 having an RGB-D sensor and a 360° lens 112, e.g., a full equirectangular or cylindrical panorama-capable image recording device. The RGB-D sensor's data may be used to virtually recreate the conference room and parse multiple perspective videos from the 360° panoramic video. In some embodiments, device 110 comprises input/output (I/O) modules for audio information, e.g., directional microphones, audio modules for outputting audio, e.g., speakers, control information, e.g., mouse or keyboard instructions, and visual information, e.g., a monitor having a GUI, as well as a processing module for processing the multimedia conference data. The device 110 may be configured to exchange conference data over a network 114, e.g., an Internet Protocol (IP) network, comprising a multimedia conference server 116 to a second location having a second multimedia conference device 118 having a lens 120, which may be substantially similar to device 110 and lens 112. In some embodiments, the multimedia conference server 116 may perform at least a portion of the processing/storage steps described herein. Participants or end users 122-128 are shown around the multimedia conference device 118. Those of skill in the art will recognize that the multimedia conference may be simulcast to a plurality of substantially similar locations within the scope of this disclosure. Additionally, various admission control techniques may be employed to authenticate and/or add additional simulcast meeting locations.

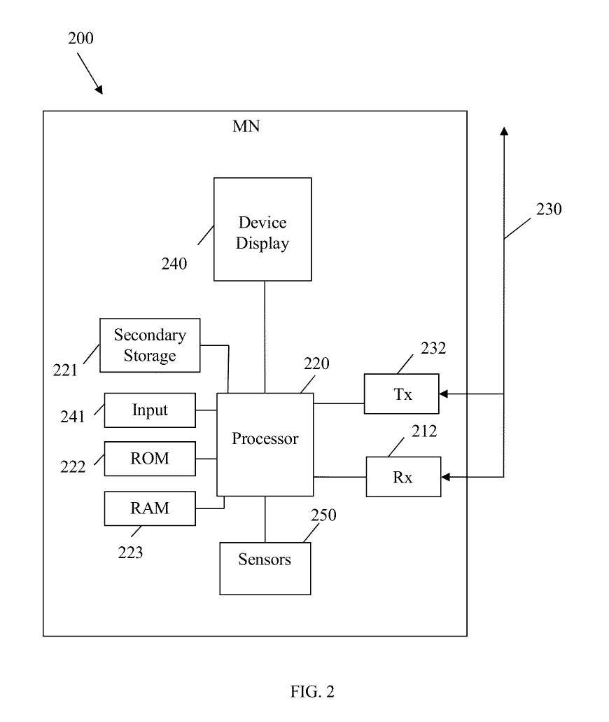

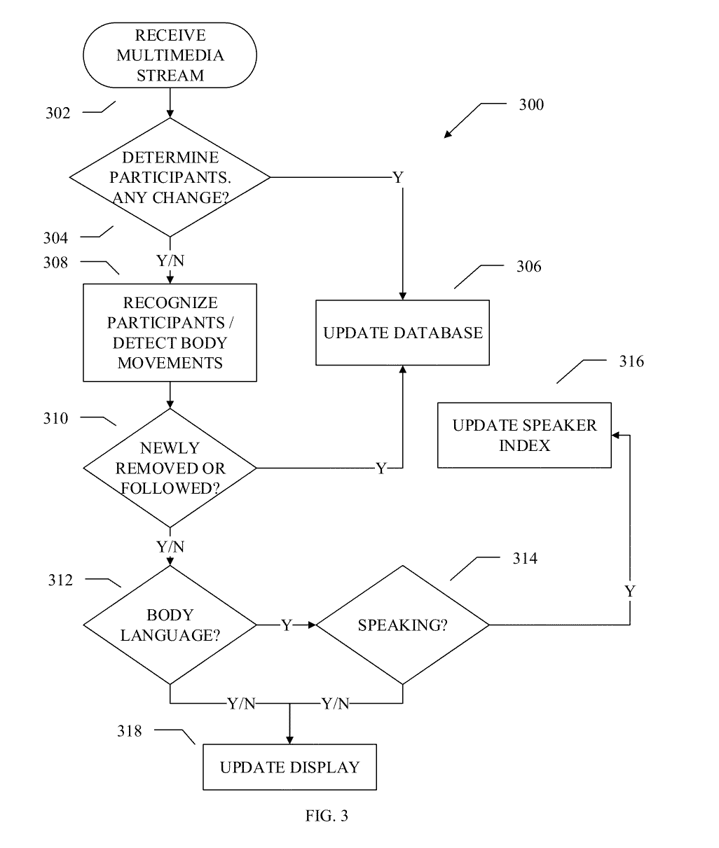

FIG. 2 is a schematic diagram of an embodiment of a device 200, which may comprise multimedia conferencing devices 110 or 118. The device 200 may comprise a two-way communication device having video, voice, and/or data communication capabilities. The device 200 generally has the capability to communicate with other computer systems on the Internet and/or other networks, e.g., network 114. At least some of the features/methods described in the disclosure, for example a process of capturing and/or processing multimedia conference information using a multimedia conference device as described in FIG. 3, may be implemented in in a device such as device 200.

The device 200 may comprise a processor 220 (which may be referred to as a central processor unit (CPU)) that may be in communication with memory devices including secondary storage 221, read only memory (ROM) 222, and random access memory (RAM) 223. The CPU 220 may be implemented as one or more general-purpose CPU chips, one or more cores (e.g., a multi-core processor), or may be part of one or more application specific integrated circuits (ASICs) and/or digital signal processors (DSPs). The CPU 220 may be implemented using hardware, software, firmware, or combinations thereof.

The secondary storage 221 may be comprised of one or more solid state drives and/or disk drives which may be used for non-volatile storage of data and as an over-flow data storage device if RAM 223 is not large enough to hold all working data. Secondary storage 221 may be used to store programs that are loaded into RAM 223 when such programs are selected for execution. The ROM 222 may be used to store instructions and perhaps data that are read during program execution. ROM 222 may be a non-volatile memory device and may have a small memory capacity relative to the larger memory capacity of secondary storage 221. The RAM 223 may be used to store volatile data and perhaps to store instructions. Access to both ROM 222 and RAM 223 may be faster than to secondary storage 221.

The device 200 may comprise a receiver (Rx) 212, which may be configured for receiving data, packets, or frames from other components. The Rx 212 may be coupled to the CPU 220, which may be configured to process the data and determine to which components the data is to be sent. The device 200 may also comprise a transmitter (Tx) 232 coupled to the CPU 220 and configured for transmitting data, packets, or frames to other components. In some embodiments, the Rx 212 and Tx 232 may be coupled to an antenna (not pictured), which may be configured to receive and transmit wireless signals.

The device 200 may also comprise a device display 240 coupled to the processor 220, for displaying output thereof to a user. The device display 240 may comprise a light-emitting diode (LED) display, a Color Super Twisted Nematic (CSTN) display, a thin film transistor (TFT) display, a thin film diode (TFD) display, an organic LED (OLED) display, an active-matrix OLED display, or any other display screen. The device display 240 may display in color or monochrome and may be equipped with a touch sensor based on resistive and/or capacitive technologies.

The device 200 may further comprise input devices 241 coupled to the processor 220, which may allow a user to input commands to the device 200. In the case that the display device 240 comprises a touch sensor, the display device 240 may also be considered an input device 241. In addition to and/or in the alternative, an input device 241 may comprise a mouse, trackball, built-in keyboard, external keyboard, and/or any other device that a user may employ to interact with the device 200. The device 200 may further comprise sensors 250 coupled to the processor 220. Sensors 250 may detect and/or measure conditions in and/or around device 200 at a specified time and transmit related sensor input and/or data to processor 220.

It is understood that by programming and/or loading executable instructions onto the device 200, at least one of the Rx 212, processor 220, secondary storage 221, ROM 222, RAM 223, antenna 230, Tx 232, input device 241, display device 240, and/or sensors 250, are changed, transforming the device 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

FIG. 3 is a flowchart describing a process 300 of capturing and/or processing multimedia conference information using a multimedia conference device. As will be understood by those of skill in the art, one or more steps of process 300 may be accomplished at a multimedia conference device, e.g., device 110 or 118 of FIG. 1, at a server, e.g., server 116, at another processing device, or with some steps performed at different components. The process 300 may begin at 302 with receiving a multimedia stream, e.g., at device 110 of FIG. 1, and may proceed with decoding the video data of the multimedia stream into various spatial resolutions and temporal resolutions suitable for display on a GUI. At 304, the process 300 may determine the participants, e.g., participants or end users 102-108 and/or 122-128, by analyzing the decoded video stream. If no participants are recorded in the participant database, e.g., as stored on a secondary storage 221 of FIG. 2, entries may be created for the participants at the participant database. If participant entries exist at the participant database, at 304 the process 300 may review the participants to determine whether constant participants are present, e.g., by determining whether participants are entering or leaving the meeting, e.g., by identifying whether new participants are entering or old participants are exiting the multimedia data stream. If participants are entering or exiting the conference, at 306 the participant database may be updated to add/drop participants and the process 300 may continue to 308. If not, at 308 the process 300 may proceed to recognize the participants, e.g., using facial recognition information, physical location tagging, etc. At 308, the process 300 may further detect body movements in the single stream. At 310 the process 300 may check to see whether the process 300 has been configured to follow one or more specific users, e.g., by selecting certain users through a GUI at an end user display device. If so, the process 300 may update the participant database, as stored on a secondary storage 221 of FIG. 2, at 306 and the process 300 may continue to 312. If not, at 312 the process 300 may evaluate the body language of the participants to heuristically discern whether any participants are showing body language indicating that an important action is taking place, e.g., standing up, gesturing, etc. If so, at 314 process 300 may evaluate whether the participant of concern is speaking by analyzing additional interest activities, e.g., by discerning whether the participant's lips are moving, and/or if a difference in the (optionally directional) audio stream has been noted. This interest activity information may be used, e.g., to distinguish between simply taking notes, scratching, yawning, etc. If so, at 316 the process 300 may update a speaker index, e.g., by updating a table recording the identities of the participants in the meeting who speak or gesture in order to identify key participants for GUI display. At 318, the process 300 may update the GUI display, e.g., to show perspective video (e.g., conventional, horizontally displayed non-360° video) of each of the participants according to the most recent configuration settings, to change focus to perspective video of an active speaker (e.g., pop-up focus type), to show perspective video of participants entering or exiting the meeting, etc. Collectively, the process 300 from 304 to 316 may comprise a detection, heuristic learning, and presentation phase, e.g., by detecting the activity, learning the activities presented and key participants over a period of time, and optimizing the presentation on a GUI to accurately present the key participants in an easily intelligible way.

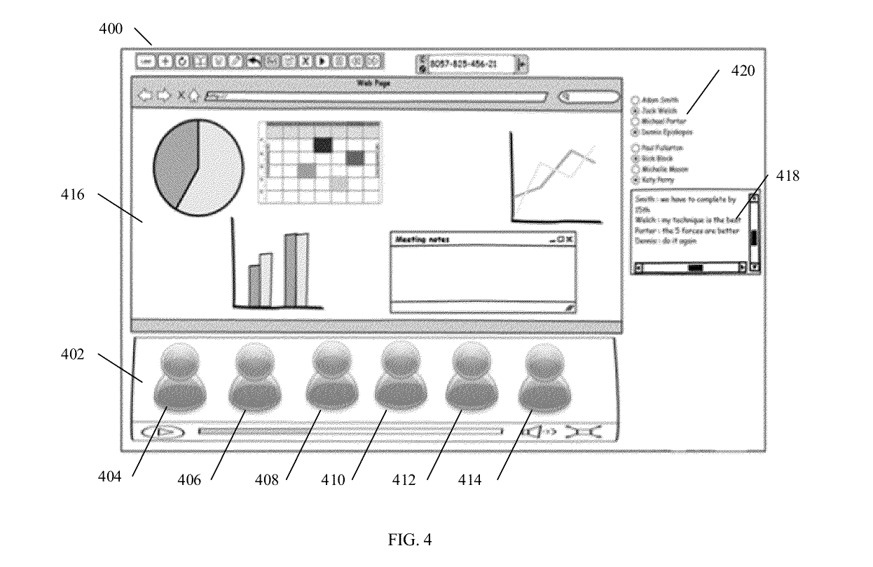

FIG. 4 is a first embodiment of a GUI 400 for a visual display at an end user location for a multimedia conference, e.g., conference 100 of FIG. 1, utilizing an embodiment of a process of capturing and/or processing multimedia conference information, e.g., process 300 of FIG. 3. GUI 400 may be displayed in an Internet web browser or may be displayed via other software, e.g., a stand-alone device. GUI 400 may comprise a participant display area 402 for displaying perspective video of users 404-414, e.g., any of users 102-108 and/or 122-128 of FIG. 1. Display area 402 may display users in a single strip according to a predefined configuration, e.g., by title, seating location, etc., or dynamically, e.g., by placing the users in order of most talkative to least talkative. Display area 402 may comprise a scroll bar for panning across video of various users if the display area is not large enough to accommodate video of all the participants in the conference, e.g., if displayed on the screen of a mobile device. Display area 402 may comprise selectable buttons or widgets for following/un-following any of users 404-414 and/or for closing, hiding, subduing, and/or minimizing the video display of any of the individual users 404-414 inside display area 402. GUI 400 may also comprise a display area 416 for displaying data accompanying the multimedia conference, e.g., presentation slides, group chat windows, camera feeds, documents, calendars, virtual whiteboards, meeting notes, graphs, spreadsheets, etc., and may comprise indicia of the actions of one or more meeting participants with respect to such data. GUI 400 may further comprise a chat window 418 for private communications between specified participants or end users. GUI 400 may further comprise a participant roster 420 and may utilize the roster for various purposes, e.g., for tracking speakers, for designating key individuals, for monitoring new participants, etc. The participant roster 420 may have some identifying information for each participant 404-414, including a name, location, image, title, e-mail address, phone number, and so forth. The participants 404-414 and identifying information for the participant roster 420 may be derived from a meeting console used to join the multimedia conference event. For example, any one or more participants 404-414 may use a meeting console to join a virtual meeting room for a multimedia conference event. Prior to joining, the participant 404-414 may provide various types of identifying information to perform authentication operations with the multimedia conference server, e.g., server 116 of FIG. 1. Once the multimedia conference server authenticates the participant 404-414, the participant 404-414 may be allowed to access the virtual meeting room, and the multimedia conference server may be the identifying information to the participant roster 420.

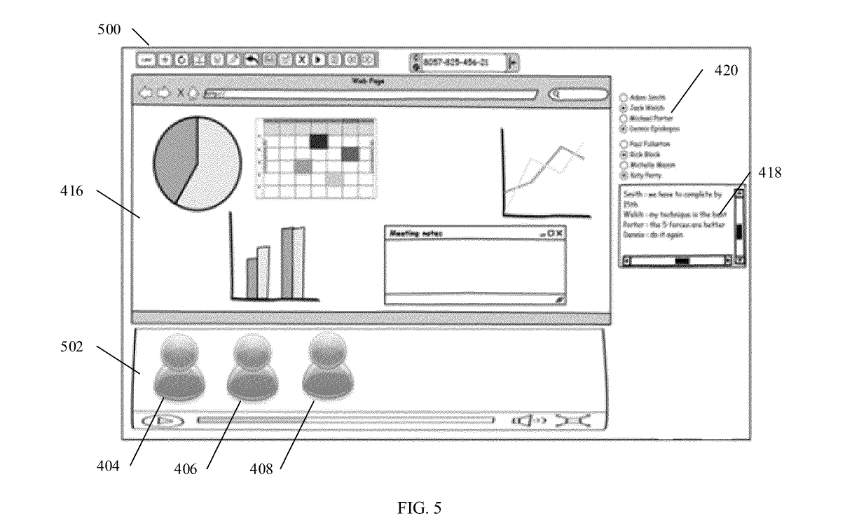

FIG. 5 shows a second embodiment of a GUI 500 for a visual display at an end user location for a multimedia conference, e.g., conference 100, utilizing an embodiment of a process of capturing and/or processing multimedia conference information, e.g., process 300. GUI 500 may be substantially similar to GUI 400 except as noted. GUI 500 has a display area 502. Unlike display area 402, display area 502 may display video of particular users based on an automatic average of the top n repeat activities, e.g., speaking, standing, etc., where n is a variable number. For example, a heuristic approach may be utilized to assign a prominence score to participants at a speaker index, e.g., the speaker index of 316 of FIG. 3, by compiling the number of desired events, e.g., speaking, and ranking participants 404-414 based on the weighted scores. These scores may be useful for dynamically adjusting, altering, or otherwise changing the present display as well as for anticipating future activity (and thereby future displays). The monitored activities may further be tied to a time metric. For example, a decay function may be introduced to reduce the weight of the n occurrences of a repeat activity based on the amount of time which has passed since the last occurrence. In another example, the duration of the occurrence can be used to determine the identity of the primary participants, e.g., to ensure that a participant who speaks once for forty minutes is ranked higher than a participant who asks three brief questions.

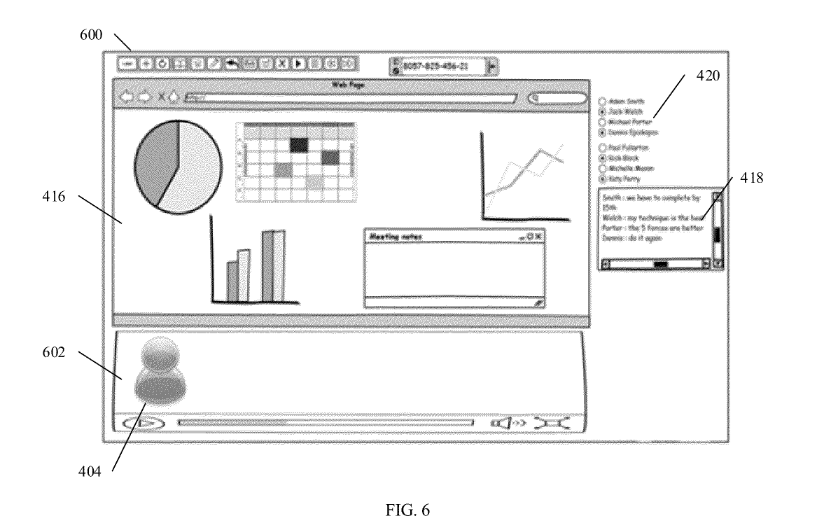

FIG. 6 shows a third embodiment of a GUI 600 for a visual display at an end user location for a multimedia conference, e.g., conference 100 of FIG. 1, utilizing an embodiment of a process of capturing and/or processing multimedia conference information, e.g., process 300. GUI 600 may be substantially similar to GUI 500 except as noted. GUI 600 has a display area 602. Unlike display area 502, display area 602 may automatically display the current activity, e.g., a presenter speaking, in a current activity view. By dynamically determining the current speaker/doer participant, e.g., any of participants 404-414, the view shown in the display area 602 may be focused on the current speaker/doer. This may be particularly useful for limited display areas, e.g., mobile devices, but may also serve aesthetic purposes.

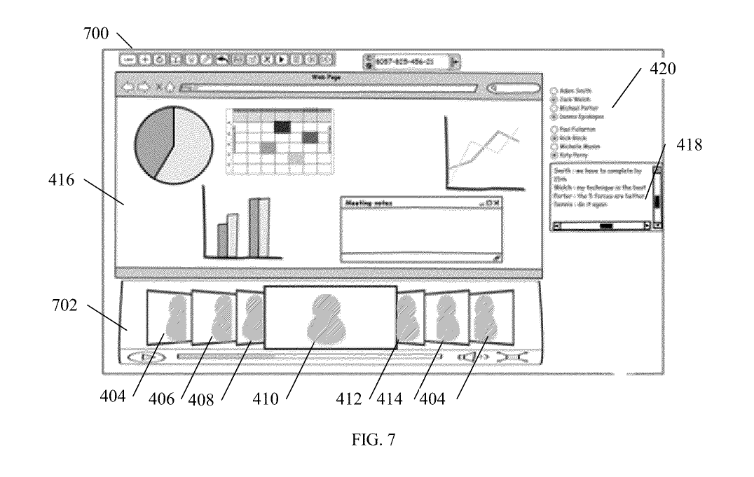

FIG. 7 shows a fourth embodiment of a GUI 700 for a visual display at an end user location for a multimedia conference, e.g., conference 100, utilizing an embodiment of a process of capturing and/or processing multimedia conference information, e.g., process 300. GUI 700 may be substantially similar to GUI 600 except as noted. GUI 700 has a display area 702. Unlike the strip style views of display areas 402, 502, and/or 602, display area 702 employs a carousel view. As shown, because display area 702 comprises a carousel view, user 404 is displayed twice due to the limited number of participants or users 404-414. Similar to display area 602, the carousel view of 702 may dynamically determine the current speaker/doer and place the current speaker/doer in a visually prominent position, e.g., in an enlarged center carousel panel. Adjacent users and/or participants 404-414 may be sequenced similar to display area 502, e.g., according to an average of the top n repeat activities, or may be displayed based on predefined criteria similar to display area 402. Notably, any or all of the embodiments shown in FIGS. 4-7 may be incorporated into the same product as alternative interfaces for a multimedia conference display, as well as a variety of other such embodiments as would be readily apparent by those of skill in the art.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=R₁+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. All documents described herein are incorporated herein by reference.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A conferencing apparatus comprising:
a memory;
a processor coupled to the memory, wherein the memory contains instructions that when executed by the processor cause the apparatus to:
receive a video stream;
evaluate the video stream for a plurality of participants;
detect an interest activity of at least one of the plurality of participants; and
increase a prominence of a portion of the video stream associated with the at least one of the plurality of participants based on the detected activity.

2. The apparatus of claim 1, wherein the video stream comprises 360° panoramic video data, and wherein the portion of the video stream associated with the at least one of the plurality of participants comprises a perspective view of the at least one of the plurality of participants.

3. The apparatus of claim 1, wherein the instructions further cause the apparatus to increase the prominence of the portion of the video stream comprises the memory containing instructions to dynamically update a prominence score associated with the at least one of the plurality of participants.

4. The apparatus of claim 3, wherein each participant in the participant roster is assigned a prominence score based on a number of interest activities recorded over time, and wherein a display dynamically places participants based on the prominence score, and wherein the interest activities are selected from a group consisting of: speaking, gesturing, entering the video stream, or leaving the video stream.

5. The apparatus of claim 1, wherein the instructions further cause the apparatus to query a database to determine if at least one participant is designated for prominent placement in the display, and wherein the participant designation is either manually selected or selected based on the interest activities.

6. The apparatus of claim 1, wherein the media stream further comprises an audio stream and a data stream, and wherein the data stream comprises a document, a chat feed, or presentation slides.

7. A method of video conferencing comprising:
obtaining a first video stream;
analyzing the media stream to identify a plurality of video conference participants;
recording the identities of each participant in separate entries in a roster;
decoding the first video stream to produce a second video stream, wherein the second video stream comprises at least one perspective video of at least one participant in the video conference;
detecting an interest activity in the second video stream;
correlating the interest activity to an entry in the roster;
recording the correlation in the roster; and
configuring the second video stream to display video of the at least one participant at a location geographically remote from the camera based on the interest activity.

8. The method of claim 7, wherein configuring the second video stream further causes video of a first participant to be displayed more prominently than video of a second participant.

9. The method of claim 7, wherein interest activities are quantified based on number or duration.

10. The method of claim 7, wherein the roster comprises data indicating a prominence score for each participant, wherein the second video stream is configured at least in part based on the prominence score of the at least one participant, and wherein a higher prominence score of a second participant in the first video stream will cause the second video stream to display video of the second participant more prominently than video of the at least one participant.

11. The method of claim 10, wherein the first video stream comprises 360° panoramic video data captured using a camera equipped with a red, green, blue plus depth (RGB-D) sensor.

12. The method of claim 7, further comprising:
obtaining a second media stream from the geographically remote location, wherein the second media stream comprises a third video stream captured using a 360° camera equipped with a RGB-D sensor;
analyzing the second media stream to identify a second plurality of video conference participants;
recording the identities of each participant in the second plurality in separate entries in the roster;
decoding the third video stream to produce a fourth video stream, wherein the fourth video stream comprises at least one perspective video of at least one participant from the second plurality;
detecting a second interest activity in the fourth video stream;
correlating the second interest activity to a second entry in the roster;
recording the second correlation in the roster; and
configuring the fourth video stream to display video of the at least one participant from the geographically remote location at the location of the camera based on the second interest activity.

13. The method of claim 12, wherein at least a portion of the first plurality of participants is displayed alongside the second plurality of participants at the geographically remote location and at the location of the camera.

14. The method of claim 7, wherein configuring the second video stream comprises synchronizing display of the second video stream with the audio stream and with the display of a document, a chat feed, or presentation slides.

15. A computer program product comprising computer executable instructions stored on a non-transitory medium that when executed by a processor cause the processor to:
identify a first participant and a second participant in a video conference media stream;
record the identities of the first participant and the second participant in a roster;
detect an interest activity from the first participant;
using the occurrence of the interest activity to generate a prominence score;
recording the prominence score in the roster; and
prepare a display stream comprising the first participant and the second participant depicted in a perspective view according to their prominence score.

16. The computer program product of claim 15, wherein depicting the first participant and the second participant according to their prominence score comprises making the display of the first participant bigger, higher, more centrally located on the display, or in a different hue, contrast, or color relative to the display of the second participant.

17. The computer program product of claim 15, wherein generating the prominence score comprises counting the number of total interest activities associated with the first participant, measuring the duration of the detected interest activity, or both.

18. The computer program product of claim 15, wherein the video stream was captured using a 360° panoramic camera.

19. The computer program product of claim 15, wherein the display stream further comprises an audio stream and a document, a chat feed, or presentation slides.

20. The computer program product of claim 15, wherein the prominence score is time decayed.
